(19) United States
(12) Patent Application Publication
(10) Pub. No.: US 2004/0224293 A1
(43) Pub. Date: Nov. 11, 2004

(54) Worker specific health and safety training

(75) Inventors: Paula J. Penning, Stillwater, MN (US); John C. Mathison, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/431,716

(22) Filed: May 8, 2003

(51) Int. Cl. G09B 19/00

(52) U.S. Cl. 434/219

(57) ABSTRACT

A system, method, or apparatus for use in providing worker specific health and safety training (e.g., individualized training for each of a plurality of trainee individuals with respect to a particular configuration of respirator or other health and safety equipment and information).

### BACKGROUND OF THE INVENTION

The present invention relates generally to the training of individuals. More particularly, the present invention pertains to systems, apparatus, and methods for use in providing worker specific health and safety training of individuals, e.g., online worker specific training of persons (e.g., employees) relating to one or more workplace conditions (e.g., use of a respirator, use of hearing protection, existence of potential exposure to chemical hazards, etc.).

In many situations, training of individuals with respect to health and safety issues is required, e.g., an employer may be responsible for training employees. For example, the Occupational Safety and Health Administration (OSHA) requires the use of health and safety protective equipment and other related safe practices, such as hazard communications. OSHA may require annual training for such equipment and practices. Such training requirements, at least in one or more circumstances, may dictate that each training topic require a review of workplace specific information (e.g., specific instruction regarding a particular respirator, relaying of information regarding a particular chemical hazard, etc.).

One particular example of a training requirement is an OSHA requirement for annual respiratory protection training. In addition, the National Institute for Occupational Safety and Health (NIOSH) and the American National Standard Institute (ANSI) have recommended components that should be included in a comprehensive respiratory training program. For example, such content requirements may include:

1. Why a respirator is necessary and how improper fit, usage or maintenance can compromise the protection afforded by the respirator.

2. The function, limitations and capabilities of the respirator.

3. How to use the respirator effectively in emergency situations, including situations in which the respirator malfunctions and use of emergency escape devices.

4. How to inspect, put on, check the face seal, use and remove the respirator.

5. The procedures for maintenance and storage of the respirator.

6. How to recognize medical signs and symptoms that may limit or prevent effective use of respirators.

7. The general requirements of the OSHA respiratory protection standard, 42 Code of Federal Regulations Part 1910.134.

8. A link to a hazard communication training program or hazard communication coordinator for cross training on respirators.

9. An explanation of the nature of the respiratory hazard and what happens if the respirator is not used properly.

10. The need to inform the supervisor of any problem experienced by a worker or a co-worker.

11. Any engineering and administrative controls being used.

As illustrated above, at least some of the components of the training are specific to the particular employee=s workplace and the type of respirator employers have specifically chosen for each of their employees. It will be recognized that, although some employees may wear a certain type of respirator, other employees in the same employee workspace may wear a different respirator. For example, such may occur if the different employees are exposed to different levels of a potentially hazardous environment.

Various off the shelf programs are available to provide training regarding various safety and health issues. However, the types of programs that are conventionally offered do not generally provide specific information adequate to meet training requirements and generally requires an employer to provide additional instructor led training to employees in order to meet the training requirement, e.g., an OSHA training requirement.

In addition to the need for additional instructor led training, other problems may arise with such programs. For example, if the training program that an employer purchases does not include all the required elements of a training requirement (e.g., such as those required for OSHA), the employer may incorrectly assume that they have met the annual training requirement. Such misinformation may expose the employer to potential citations, fines, and more importantly, does not provide employees with adequate information (e.g., an employee may not be informed properly regarding the use of their specific respirator).

One training process is described in International Application No. PCT/US01/17661 published 13 Dec. 2001, entitled “Dynamically Generating Site Specific Compliance Programs” filed in the Applicant's name of Complient (hereinafter referred to as “Complient”). Complient describes a method and system for the dynamic generation of site specific compliance programs from a generic compliance program, and administering and monitoring user adherence to comply with activities. Further, Complient describes that the dynamic generation of a site specific training course uses an expert system that identifies particular issue modules to be used in the training course. The expert system adds site specific information to the applicable modules to produce the site specific training course. The compiled site specific training course can then be transmitted to a user for display or printing through an interface device.

Such a method or system as described in Complient provides training to individuals at a site specific level. In other words, a training program is generated for a particular site regarding a plurality of issues. For example, it would appear that the system described in Complient would provide each employee at a particular site with the same training information. Such a focus on site specific information may not provide an individual worker with adequate and focused training. In other words, individuals who only have the need to be trained with respect to a particular configuration of a type of safety equipment or workplace chemical hazard may be required to use a training program that subjects the individual to unnecessary information which only detracts from the individual's training.

### SUMMARY OF THE INVENTION

The present invention provides individuals to be trained with worker specific information training that overcomes the problems of conventional health and safety training processes.

A method of the present invention for use in training individuals includes providing a standardized training program and worker specific training information. The worker specific training information includes information corresponding to each of a plurality of different training objects (e.g., different respirator configurations) for at least one workplace condition (e.g., need to don a respirator). One or more administrative individuals are allowed to provide workplace information associated with a workplace. The workplace information includes trainee identification information that identifies a plurality of trainee individuals that are each to be trained with respect to at least one training object of the plurality of different training objects for the at least one workplace condition that is associated with the workplace. Further, the workplace information includes linking information for each of the plurality of trainee individuals that provides an association between the trainee individual and the at least one training object. The method further includes assigning an identification code to each of the plurality of trainee individuals that allows each trainee individual to access the standardized training program; the identification code is preferably unique to each trainee individual. A user interface is provided to at least one of the plurality of trainee individuals using the standardized training program in association with particular training information corresponding to the at least one training object; the particular training information being selected from the worker specific training information based on at least the identification code and the linking information for the at least one trainee individual.

A computer implemented system for use in training individuals is also provided. The system includes at least one application server operable for communicating with one or more databases and further operable for communicating with one or more user computers. The system also includes a standardized training program and worker specific training information stored in at least one of the databases. The worker specific training information includes information corresponding to each of a plurality of different training objects for at least one workplace condition. The computer implemented system is operable for use in providing an administrative interface on at least one of the user computers adapted to allow one or more administrative individuals having access to the at least one application server to provide workplace information associated with a workplace. The workplace information includes trainee identification information that identifies a plurality of trainee individuals that are each to be trained with respect to at least one training object of the plurality of different training objects for the at least one workplace condition that is associated with the workplace. Further, the workplace information includes linking information for each of the plurality of trainee individuals that provides an association between the trainee individual and the at least one training object. The system is further operable to provide assignment of an identification code to each of the plurality of trainee individuals that allows each trainee individual to access the application server; the identification code is preferably unique to each trainee individual. Yet further, the system is operable to provide a user interface adapted for use in training at least one of the plurality of trainee individuals using the standardized training program in association with particular training information corresponding to the at least one training object; the particular training information being selected from the worker specific training information based on at least the identification code and the linking information for the at least one trainee individual.

Yet further, a user interface is provided for use in training individuals using a standardized training program and worker specific training information. The worker specific training information includes information corresponding to each of a plurality of different training objects for at least one workplace condition. The user interface includes an administrative interface adapted to allow one or more administrative individuals to provide workplace information associated with a workplace. The workplace information includes trainee identification information that identifies a plurality of trainee individuals that are each to be trained with respect to at least one training object of the plurality of different training objects for the at least one workplace condition that is associated with the workplace. Further, the workplace information includes linking information for each of the plurality of trainee individuals that provides an association between the trainee individual and the at least one training object. An identification code is assigned to each of the plurality of trainee individuals that allows each trainee individual to access the standardized training program. At least the identification code and the linking information for at least one trainee individual are used in providing a user interface using the standardized training program in association with particular training information corresponding to the at least one training object; the particular training information selected from the worker specific training information.

An online training system according to the present invention includes a user computer apparatus and at least one application server operable for communicating with one or more databases and further operable for communicating with the user computer apparatus. The system further includes a standardized training program and worker specific training information stored in at least one of the one or more databases; the worker specific training information includes information corresponding to each of a plurality of different training objects for at least one workplace condition. The online training system through use of the application server is operable to provide an administrative interface adapted to provide one or more administrative individuals with access to the application server to allow the one or more administrative individuals to provide workplace information, such as that described with respect to the interface above, associated with a workplace. An identification code is assigned to each of the plurality of trainee individuals that allows each trainee individual to access the standardized training program. Further, a user interface is provided using the user computer apparatus for use in training the at least one trainee individual. The interface is provided using the standardized training program in association with particular training information corresponding to at least one training object selected from the worker specific training information based on at least an identification code for the individual and linking information provided by the administrator.

An online training method is also described. The method includes establishing a communication link between a user computer apparatus and an application server. The application server provides a standardized training program and worker specific training information. The worker specific training information includes information corresponding to each of a plurality of different training objects for at least one workplace condition. An identification code assigned to a trainee individual is used to access the standardized training program and a user interface is provided via the user computer apparatus to the at least one trainee individual using the standardized training program in association with particular training information corresponding to at least one training object of the plurality of training objects. The particular training information is selected from the worker specific training information based on at least the identification code.

One or more of the following features may be employed in one or more of the methods, systems, and/or interfaces described herein. For example, the information corresponding to each of a plurality of different training objects may include information corresponding to each of a plurality of different types of environmental hazards. The information corresponding to each of a plurality of different training objects may include information corresponding to each of a plurality of different configurations for a type of safety equipment (e.g., information corresponding to each of a plurality of different configurations for at least one of respirator equipment, hearing protection and hearing loss prevention control equipment, physical body support equipment, eye and face protection equipment, head protection equipment, foot protection equipment, and skin protection equipment).

Further, for example, providing the user interface may include displaying at least a portion of the worker specific training information and requiring a trainee individual to verify the accuracy of the portion of the worker specific training information; displaying at least a portion of particular training information corresponding to at least one training object for which a trainee individual is to be trained and requiring the trainee individual to provide one or more responses concerning the portion of the particular training information; providing information related to the maintenance of a particular configuration of safety equipment and requiring a trainee individual to provide one or more responses concerning the information related to the maintenance of the safety equipment; displaying an illustration of a particular configuration of a type of safety equipment and providing a trainee individual with information that requires one or more responses from the trainee individual concerning the illustration (e.g., requires the at least one trainee individual to identify one or more parts of the configuration of respirator equipment using an illustration thereof); and displaying information associated with wearing a configuration of safety equipment and requiring a trainee individual to provide one or more responses concerning the information.

The above summary of the present invention is not intended to describe each embodiment or every implementation of the present invention. Advantages, together with a more complete understanding of the invention, will become apparent and appreciated by referring to the following detailed description and claims taken in conjunction with the accompanying drawings.

### BRIEF DESCRIPTION OF THE DRAWINGS

FIG. 1 shows an illustrative block diagram of one general embodiment of a training system according to the present invention.

FIG. 2 shows a flow diagram of one general embodiment of a training method according to the present invention that may be implemented using the system of FIG. 1.

FIG. 3 shows one illustrative block diagram of at least portions of a respirator training system that may be employed as generally shown in FIG. 1 according to the present invention.

FIG. 4 shows a flow diagram of one embodiment of a respirator training method that may generally be implemented using the system components shown in FIG. 3.

FIG. 5 shows an introduction screen to be used in describing one or more training systems and/or methods, or portions thereof, according to the present invention.

FIG. 6 shows a respirator parts identification screen for use in describing one or more training methods and/or systems, or portions thereof, according to the present invention.

FIG. 7 shows a donning respirator screen for use in describing one or more training methods and/or systems, or portions thereof, according to the present invention.

### DETAILED DESCRIPTION OF THE EMBODIMENTS

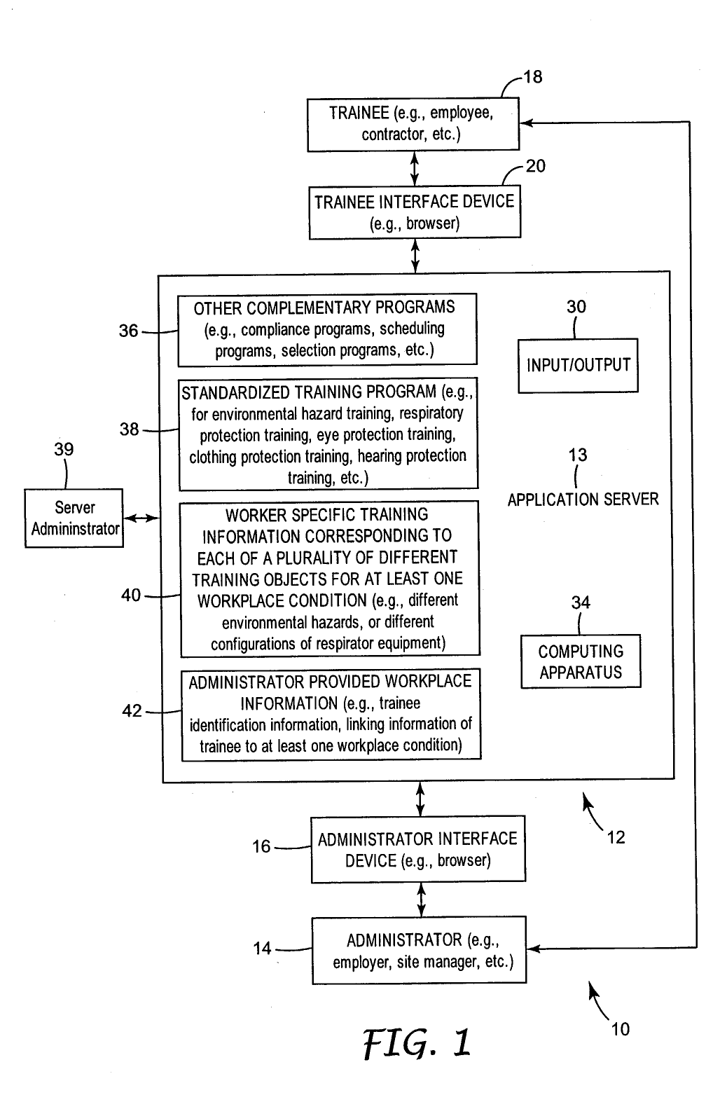

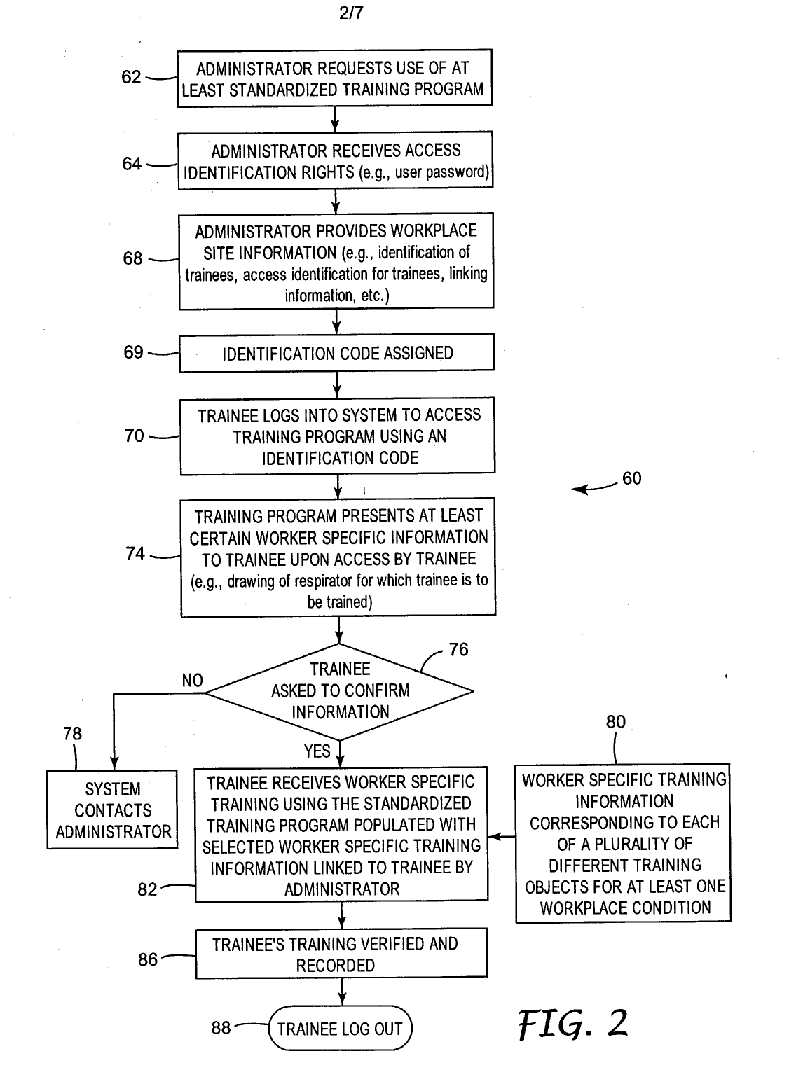

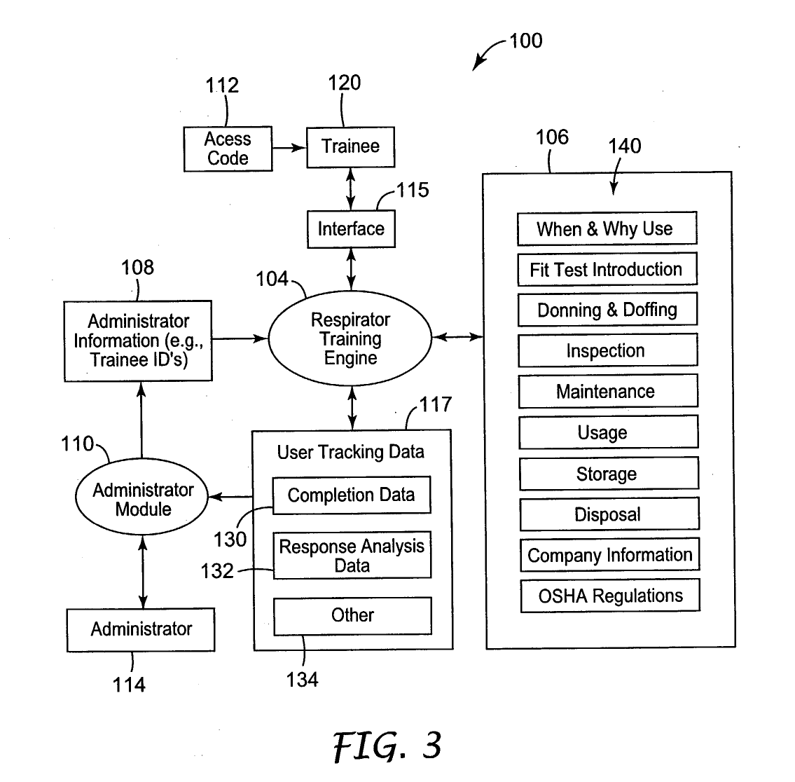

The present invention shall be described generally with reference to FIGS. 1-2. Thereafter, one or more embodiments of the present invention shall be described with reference to the remaining FIGS. 3-7.

FIG. 1 shows a block diagram of one embodiment of a general training system 10 according to the present invention. The block diagram of FIG. 1 illustrates the system that can be implemented by hardware and software architecture according to the present invention.

The training system 10 provides for the training of one or more trainee individuals 18 using worker specific training information, e.g., information specifically linked to an individual being trained. The training system 10 is an interactive training system in which trainee individuals 18 may be trained with use of a training interface device 20 that is operable for communication with an application server architecture 12. Such training is controlled by at least one administrator individual 14 that is in communication with the application server architecture 12 using an administrator interface device 16.

Generally, the training system 10 is operable to implement worker specific training. For example, a generic training program (e.g., standardized training program or engine 38) that provides a training shell which can be populated with selected worker specific training information is used. For example, worker specific training information with regard to a plurality of training objects (e.g., information corresponding to a plurality of respirators, to hearing protection devices, to eye and face protection devices, to head protection apparatus, to foot protection apparatus, including hazard communication, toxicology information, and industrial hygiene issues) is provided. The training system 10 is operable to allow the administrator individual 14 to provide workplace information, such as, for example, trainee identification information identifying any number of trainee individuals 20 who are to be trained by the system 10. Further, the administrator individual 14 provides information, or otherwise takes one or more actions, with regard to each of the individuals to be trained that provides an association (e.g., a link) between the trainee individual and at least one training object for which the individual is to be trained (e.g., a particular make and model of respirator that is to be worn by the individual to be trained).

An identification code is assigned to each of the trainee individuals 20 which allows each of the trainee individuals 18 to access the training system 10. Each trainee individual 18 upon access to the training system 10 using the identification code is provided with a user interface, e.g., a graphical user interface such as an interactive graphical user interface.

A user interface includes any program that controls the presentation of information and/or any presentation of information to a user. Typically, a user interface allows a user to interact (e.g., perceive visual or audio information, input responses, etc.) with a system (e.g., the application server architecture 12) to which the user is interfaced. The user interface may be provided as a graphical user interface that may include the presentation of the information in graphical form (e.g., using icons, pictures, menus, etc.) in addition to textual information. For example, various input devices may be used to provide for interaction with the system (e.g., the application server architecture 12), such as keyboard, mouse, light pen, etc. Any level of user interaction is contemplated according to the present invention (e.g., visual perception whether or not any action is taken by the user, response to a graphical illustration via an input device, etc.)

The user interface (e.g., the training shell or standardized portion of the interface) is populated with training information corresponding to the at least one particular training object to which the trainee individual 20 has been linked under control of the administrator individual 14 (e.g., training information selected from the worker specific training information corresponding to the particular training object). For example, if a particular respirator make and model is linked to the trainee individual 18 by the administrator individual 14, then worker specific information corresponding to the particular respirator is used to provide the user interface to the trainee individual 18. In other words, the training information selected from the available worker specific training information for use in providing the user interface to the trainee individual is selected based on the identification code for the trainee individual 18 and the administrator information that provides an association (e.g., a link) between the trainee individual and at least the one training object for which the individual is to be trained (e.g., a particular make and model of respirator).

Using the training system 10 where particular worker specific training information (e.g., information concerning a particular respirator make and model) is linked to a particular trainee individual 18 may provide one or more of the following advantages. For example, the trainee individual is subjected to only information relating to a particular piece of equipment (e.g., a particular respirator configuration) as opposed to a generic program that provides information about multiple numbers of respirators even though the trainee individual is to be donning only one of the respirators. Further, for example, each worker at a workplace may be provided with a specific training program focused at only the health and safety concerns that the particular individual to be trained may experience. For example, at one particular workplace, an individual may be required to wear a half-face respirator, may potentially be exposed to a first chemical type, etc. At the same workplace, a second employee may be required to wear a full face respirator and may potentially be exposed to much different levels of a first chemical type or even an entirely different chemical type. With use of the present invention, worker specific training information is selectively linked to particular trainee individuals. Upon access to the training system 10 by trainee individuals 18, only selected information based on, for example, administrative information, is used to populate the user interface such that each trainee individual receives individualized worker specific training.

As used herein, workplace may refer to any definable unit that may or may not be identifiable by location, department, company, etc. In other words, workplace refers only to the grouping of a plurality of trainee individuals by some definable criteria. Such criteria may include, for example, location, department, company, floor of building, warehouse, other geographical area, job description, and/or processes at a facility. However, the present invention is clearly not limited to such workplace criteria as the criteria that may be used to define such groups of trainee individuals are too numerous to completely list.

The training system 10 illustrated in FIG. 1 includes the application server architecture 12 that exchanges information (e.g., via a network) with the trainee individuals 18, at least one administrator individual 14, and any other individuals that may require an exchange of information to or from the application server architecture 12. For example, such other individuals may include server administrators 39 that may be used to manage the server application architecture 12, e.g., update and maintain one or more databases, one or more training programs, etc.

The administrator individual 14 may be one or more different individuals depending upon the particular use of the training system 10. For example, the administrator individual 14 may include an employee of a particular company, may include a workplace manager (e.g., a department supervisor or a subsidiary management employee), or may include any other individual having the ability to provide information relating to the workplace, including, for example, training identification information, linking information, etc.

The trainee individuals 18 may include any individuals to be trained with respect to one or more different workplace conditions. For example, the trainee individuals 18 may be employees of a company, independent contractors, a site manager, visiting personnel, etc. It will be recognized that a trainee individual 18 may actually be the same as the administrator individual 14 in one embodiment where the administrator individual 14 is required to undergo health and safety training. Further, for example, in one embodiment, the trainee individual 18 to be trained with respect to a type of safety equipment need not be an individual that wears such safety equipment. In addition, the trainee individual 18 may be an individual that upon receiving the training assists in distribution of such information to one or more other individuals (e.g., distribute the information using any medium, including verbal communication, e-mail, paper, or any other communication medium).

As described herein, the application server architecture 12 may be managed by the server administrator 39. For example, as shown in FIG. 1, the server administrator 39 may maintain and manage a standardized training program 38, one or more other complimentary programs 36, one or more databases (e.g., databases 40, 42), and any other components of the application server architecture used in providing training according to the present invention. For example, such databases may include worker specific training information database 40 for use in providing worker specific training information corresponding to each of a plurality of different training objects for one or more different workplace conditions, and/or workplace information database 42 for use in storing workplace information provided by an administrator individual 14.

In one or more embodiments of the training system 10, the server administrator 39, trainee individuals 18, and/or administrator individuals 14, may communicate directly or indirectly with an application server 13 of the architecture 12 using one or more various user interfaces through input/output 30 of the application server architecture 12. Such communication may be implemented using a network such as, for example, a local area network (LAN), a wide area network (WAN), an internet connection or the like, a public switched phone network, a dedicated data line, a cellular network, a personal communication system, microwave, satellite networks, cable or the like.

Generally, for example, the trainee individuals 18 communicate with the application server architecture 12 through a trainee interface device 20 (e.g., a browser, a computer implemented user interface, etc.). Likewise an administrator individual 14 may communicate with the application server architecture 12 using an administrator interface device 16 (e.g., a browser, a computer implemented user interface, etc.).

According to one embodiment of the invention, the interface devices (e.g., administrator interface device 16 and trainee interface device 20) which enable communication with the application server architecture 12 includes a web browser based system. For example, the web browser based system may be implemented using any interactive video display device such as a general purpose computer, a personal digital assistant (PDA), or the like. For example, various web browser software programs may enable the communications required by the interface devices with the application server architecture 12. Any interface device that results in a user interface being provided to the user may be employed. For example, any interface devices providing transmission and reception of data, and presentation of such data to the users and receipt of input from the users, may be suitable. Examples of software programs for such web browser functionality include Netscape Navigator by Netscape Communications Corporation and Internet Explorer functionality available from Microsoft Corporation.

Further, the interface devices may be capable of communicating using any suitable protocols, such as TCP/IP. Further, such communication may be employed using decryption and encryption to provide for secure transmissions using known protocols.

The application server architecture 12 generally includes a computing apparatus 34 for use in implementing the functionality as described according to the present invention. The computing apparatus 34 may include single or multiple processor based computing systems. The functionality of the present invention may be a distributed processor system. For example, a multiple processor system may be embodied as a distributed architecture with one or more processors being located at one or more different sites. It will be appreciated that almost any number of processor arrangements and architectures may be used to implement the functionality as described according to the present invention.

The application server architecture 12 used to implement one or more portions of the functionality as further described herein may utilize any number of different technologies (e.g., hardware and software) and may include various architectural configurations. For example, one or more different multi-tiered application server architectures can be used to implement the training functionality of the present invention involving any number of users.

For example, a multi-tiered architecture for an application service provider (ASP) may include three layers or tiers. A presentation tier may be a hardware/software configuration that allows a user to interface with a middle tier. For example, the presentation tier may be a browser that executes the training program's user interface with which the user directly interacts (e.g., a web browser used to provide a user interface to a trainee individual 18).

A middle or application tier may be a layer in which logic and program intelligence chiefly exists. For example, in a web-based environment, the middle tier can be thought of as having two distinct layers of its own, one in which web servers reside and one in which application servers reside. Further, for example, where certain types of web pages (e.g., simple HTML web pages) are the primary content, the serving layer of the middle tier may often be considered to be part of the presentation tier. The application server 13 provides the environment in which components, implementing portions of the training logic, reside.

Further, the last tier is a data tier where application data is stored (e.g., databases 40, 42, etc.), typically in a relational database architecture (e.g., a relational database architecture including a relational database management system (RDBMS) and data storage, such as network attached storage (NAS) and/or a storage area network (SAN)). Generally, communication occurs between tiers only, e.g., the presentation tier interacts strictly with the middle tier, and the middle tier interacts strictly with the data tier.

Although any architecture suitable for performing the functionality as described herein may be used, an exemplary architecture for a training system may be standardized on a Microsoft platform. For example, in such an exemplary architecture (e.g., a multi-tiered web application server architecture), Microsoft Internet Information Server (IIS) and its scripting engine Active Server Pages (ASP) may provide web interface services. A Microsoft SQL Server 2000 may be used to provide database services. Further, at least in one embodiment, Flash software may be used in providing content to users.

One will recognize that various other technologies, e.g., hardware or software technology, may be used to distribute requests across multiple web servers, may be used to provide firewalls, used to provide password authentication, or to provide any other functionality as described herein.

As described herein, the application server architecture 12 is operable to provide the user interface for use in training one or more trainee individuals 18. A standardized training program 38 executable by the architecture 12 provides a shell or generic information and data for use in providing the user interface to a trainee individual 18.

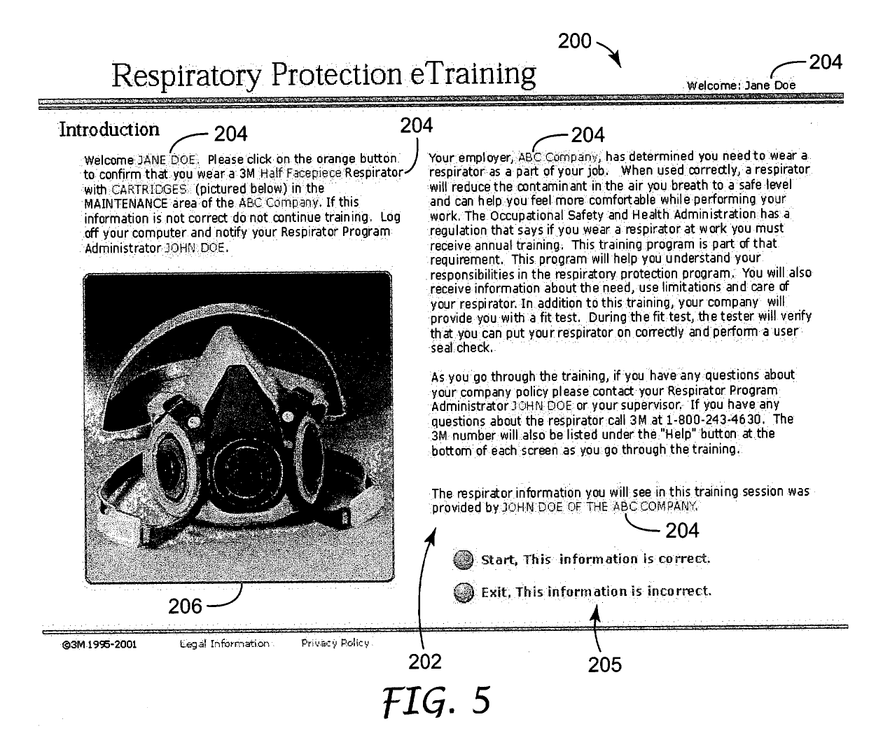

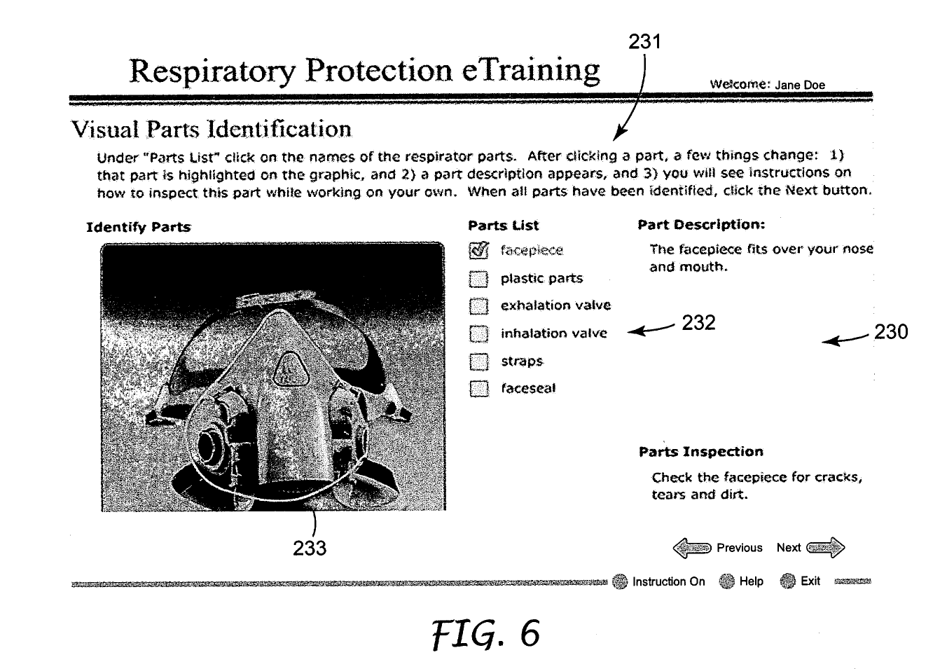

Generally, the standardized training program 38 may be any program operable to provide a shell (e.g., a generic template) that can be populated with one or more types of information depending upon the identity of the individual to be trained. For example, the standardized training program 38 may be operable for use in providing an introduction screen to the training program (e.g., the introduction screen of FIG. 5), may be operable to provide graphical information such as relating to safety and health protection equipment (e.g., graphical illustrations of a respirator as shown in FIGS. 5 and 6), and/or may be operable to provide any other training information (e.g., selected worker specific training information as further described herein), such as, for example, audio, visual and/or interactive information (e.g., a virtual reality graphical display that shows the trainee individual how to don a piece of safety equipment), links to other related websites (e.g., the 3M™ website and/or OSHA website), etc.

The standardized training program 38 may be used to provide a generic shell for any one or more different types of health and safety training for one or more different workplace conditions. A workplace condition refers to any condition (e.g., at a workplace or otherwise) for which it would be beneficial for an individual to be trained (e.g., provided with information relating to the workplace condition). For example, a workplace condition may include, but is clearly not limited to one or more different environmental hazards (e.g., chemical hazards, weather hazards, etc.), a requirement for industrial hygiene, a requirement that a trainee individual don a particular piece of respirator equipment, a requirement that the trainee individual use any one of various other types of safety equipment such as, for example, eye and face protection equipment, head protection equipment, foot protection equipment, skin protection equipment, hearing protection and hearing loss prevention control equipment, physical body support equipment, or any other safety equipment that a trainee individual may be required to use. The generic or standardized training program 38 may be used to provide a generic shell for use in providing the user interface to a trainee individual 18 for one or more of the workplace conditions (e.g., a respiratory protection training shell interface, an eye and face protection training shell, a hearing/hearing loss protection training shell, a chemical hazard shell, etc.). The standardized training program 38 may be used in combination with one or more other complimentary programs 36. The other complimentary programs may include for example, compliance programs (e.g., tracking the training of individuals), scheduling programs, selection programs (e.g., selection of protection equipment such as a particular respirator from a plurality of respirators), etc.

In one embodiment, such complementary programs may provide for medical clearance of employees such that they can be trained with respect to particular health and safety equipment. Further, in another embodiment, selection programs for selecting health and safety equipment may be used in combination with the standardized training program 38. Further, programs associated with keeping track of the completion of training and reporting of such training may also be used in combination with the standardized training program 38.

The various databases provided as part of the application server architecture 12 may include any number of databases (e.g., relational databases, data stored in tables or any number of different formats, etc.) that may be used to provide one or more different types of information. As shown in FIG. 1, the worker specific training information database 40 includes worker specific training information corresponding to each of a plurality of different training objects for one or more workplace conditions. The training objects may be any objects (e.g., not merely physical objects) that are associated with a workplace condition. For example, in one embodiment of the present invention, training objects may refer to health and safety equipment, such as respirator equipment, physical body support equipment, eye and face protection equipment, hearing protection and hearing loss prevention control equipment, head protection equipment, foot protection equipment, skin protection equipment, etc. In another embodiment, according to the present invention, training objects may relate to workplace conditions, such as environmental hazards, industrial hygiene issues, etc.

As such, worker specific training information that may be stored in database 40 that corresponds to each of a plurality of different training objects for one or more workplace conditions may include various and/or different types of information depending on the workplace condition. For example, if the workplace condition is a requirement that respirator equipment be utilized, then the worker specific training information may correspond to each of a plurality of different configurations of respirator equipment (e.g., various respirator makes and models). In other words, information corresponding to each of a plurality of different configurations of respirator equipment may be available in the database 40 (e.g., information about particular respirators made by one or more companies). Such information may include for example, a visualization of the actual respirator equipment to be used, information relating to maintenance or donning of the respirator, or any other information relating to particular configurations of the respirator equipment as will become more clear from the description of the respirator training program described herein. With such worker specific respirator training information available, the administrator individual 14 may be able to link worker specific training information for a respirator configuration available from a particular company to a trainee individual 18 such that the training for individual 18 is specifically tailored to the actual respirator equipment being worn by the individual being trained as will be further described herein.

Further, for example, in another embodiment, the worker specific training information may correspond to each of a plurality of different chemical compositions when the workplace condition is a potential exposure to chemicals. For example, the worker specific training information may include hazard communications relating to a plurality of different chemicals. As such, an administrator individual 14 can link a trainee individual 18 to one of the plurality of different types of chemicals and the hazard communications to which the trainee individual should be exposed.

One will recognize that the worker specific training information may be information in any type of form that may be perceived by a trainee individual to be used in the standardized training program for providing a user interface (e.g., an interactive graphical user interface) for training an individual. As will become clear from the description herein, such worker specific training information may include graphical information, audio information, requests for responses from a training individual, or any other information that would be useful in training an individual. Further, the information may be in the form of a subroutine run for a particular training object. For example, as will be described further herein, routines for requesting strings of responses from the trainee individual (e.g., ordering a list of items) or routines for evaluating the correctness of responses from an individual, and redirecting a query, may be used according to the present invention. The types of information corresponding to the training objects is not limited to those specifically recited herein, although certain information such as visual information that may provide ease of training for an individual may be particularly beneficial.

The workplace information provided by the administrator individual 14 may be stored in database 42 and may include one or more various types of information. In one embodiment of the present invention, the workplace information provided by the administrator individual 14 includes trainee identification information which identifies trainee individuals to be trained using the training system 10. Generally, each of the trainee individuals is to be trained with respect to at least one training object (e.g., a particular respirator configuration) of the plurality of different training objects (e.g., various different types of respirators) for the workplace condition (e.g., requirement to wear a respirator) that is associated with the workplace. Such trainee identification information may take one or more various forms such as names, social security numbers, employee identification numbers, etc.

Further, workplace information provided by the administrator individual 14 may include linking information for each of the individuals 18 to be trained. Such linking information provides an association between the trainee individual to be trained and at least one training object (e.g., a particular configuration of a respirator) selected or otherwise chosen by the administrator individual to be applicable to the trainee individual.

The linking information may be provided in various ways and may take one of various forms. For example, the administrator individual may be asked to select a particular configuration of a training object (e.g., select a particular respirator configuration from a pull-down menu) for a particular trainee individual identified by the administrator individual 14, may be asked to provide a response to a query by the administrator user interface, may be asked to fill out a form, etc.

Such a selection may be automatically associated by the system with the trainee identification information that identifies the particular trainee individual. Relational logic may be used to provide such link between the training object and the trainee individual. Flags, pointers, or any other type of linking may be provided automatically by the application server architecture 12 when certain action (e.g., selection from a pull-down menu) is taken by the administrator individual 14 associating the trainee individual and the training object.

Further, the application server architecture 12 is operable for use in providing an identification code to each of the trainee individuals identified by the administrator individual 14. In at least one embodiment, the identification code is unique to each trainee individual 18 and allows each trainee individual to access the standardized training program. The identification code may be assigned in one or more different manners.

In one embodiment, a program generating random identification codes and attaching such identification codes to each of the trainee individuals may be used. Such a random generation of identification codes provides the application server architecture 12 with the ability to service multiple administrator individuals 14 without duplication of identification codes. In another embodiment, the administrator individual 14 may choose and assign identification codes to each of the trainee individuals when such trainee individuals are entered into the system. The identification codes may take the form, for example, of any string of characters. Further, such identification codes may be stored in combination with the workplace information provided by the administrator individual 14 or in a separate database linked to the trainee individuals (e.g., the identification thereof). In addition, such identification codes may be identification information already assigned to an individual, e.g., an employee number, a company password, etc.

FIG. 2 shows a flow diagram of a training method 60 that may be implemented using a training system such as the training system 10 shown generally in FIG. 1. The training method 60 may be initiated by the administrator individual 14 obtaining access to the application server architecture 12 as shown generally in block 62. For example, when the application server architecture 12 is being maintained and updated, or otherwise managed, by a particular company, administrator individual 14 may request use of the standardized training program for training one or more trainee individuals 18 (block 62). Such requests may be made online or by any other communication medium.

The administrator individual 14, upon a grant of such a request to use at least the standardized training program, generally receives access identification rights (block 64). For example, a company administrating the application server architecture 12 may provide the administrator individual 14 with use of a password to access the application server architecture 12.

With access identification rights, an administrator individual 14 may access the application server architecture 12 using the administrator interface device 16 (see FIG. 1). For example, the administrator individual 14 may use a web browser to access the application server architecture 12.

The administrator individual 14 is provided (e.g., using the administrator interface device 16) with a user interface permitting the administrator individual 14 to provide workplace information associated with a workplace. For example, the administrator individual 14 may be a department supervisor with general knowledge of trainee individuals' roles at the workplace and/or other information necessary to adequately provide information regarding the workplace.

The user interface provided to the administrator individual 14, for example, by the administrator interface device 16, may take one of various types of forms. For example, the administrator user interface may present a series of blank forms for the administrator individual 14 to complete, may include pull down menus, may require the administrator individual 14 to answer particular requests, may be presented as queries based on responses by the administrator individual 14 to one or more requests, etc. Further, for example, at least in one embodiment, whole subjects can be addressed by tagging certain answers to open a new branch which directs the administrator to answer questions related to a higher level of detailed components. Any suitable user interface that performs the function of collecting the necessary information such that the functionality described herein may be carried out can be used.

The administrator user interface, at least in one embodiment, requires that the administrative individual 14 provide trainee identification information identifying a plurality of trainee individuals 18. Each of the plurality of trainee individuals is to be trained with respect to at least one training object of a plurality of different training objects for at least one workplace condition that is associated with the workplace for which the administrator individual 14 is providing information.

As described herein, the application server architecture 12 includes database 40 which is operable to provide various types of worker specific training information. The worker specific training information corresponds to each of a plurality of different training objects for one or more workplace conditions. For exemplary purposes, consider a workplace condition that includes an environmental hazard, such as potential exposure to a chemical. The worker specific training information available for use in the training of individuals with respect to such an environmental hazard workplace condition may include hazard communications for each of a plurality of different types of chemicals.

Administrative individual 14 provides not only the training identification information identifying one or more trainee individuals to be trained using the training system 10, but also provides linking information for each of the plurality of trainee individuals 18. As described with reference to FIG. 1, the linking information provides an association between the trainee individual and at least one training object for which the training individual 18 is to be trained. In the environmental hazard exemplary embodiment above, for example, the linking information provided by the administrator individual 14 may be information that the particular trainee individual may be exposed to a particular chemical A and thus needs training related thereto.

In one embodiment, the linking information may be provided, for example, by the administrator individual 14 defining a job description that includes a particular training object for a workplace condition (e.g., defines that the training object is a particular chemical A for which the trainee individual may be exposed). Thereafter, by assigning one or more of the trainee individuals to that particular job description a link between the worker specific training information for the training object (e.g., hazard communication information relating to the particular chemical A) and the particular trainee individual 18 to be trained with respect to the training object is established.

Any type of linking information may be used for linking information corresponding to at least one training object (e.g., hazard communication information for a particular chemical A) to a particular trainee individual 18 that requires training for a workplace condition (e.g., potential exposure to chemicals) defined by the administrator individual 14. Although the administrator individual 14 may input information that may apply to multiple individuals, at some point in the process, the administrator individual 14 provides a link between each trainee individual and the particular training object to which the particular trainee individual is to be trained. By linking each trainee individual 18 to at least one training object of the plurality of different objects for which worker specific training information is available in database 40, individualized and interactive training can be provided for each of the trainee individuals 18.

One feature of the present invention that is available, at least in one embodiment, is that the administrator individual 14 has the ability to identify trainee individuals and provide a link to information for a particular respirator make and model that is being worn by particular trainee individuals. The worker specific information that corresponds to this particular make and model of respirator can be then used to populate a shell interface provided by the standardized training program 38 (see FIG. 1) such that the individual trainee may be trained specifically with regard to this make and model of respirator. This individualized training is provided at least in part by the link provided by the administrator individual 14 between the particular training individual and the training object (e.g., the make and model of respirator) for which the individual is to be trained.

After the workplace information is provided by the administrator (block 68), an identification code is assigned to each of the trainee individuals 18 that are to be trained using the training system and which were identified by the administrator individual 14 (block 69). The identification code is unique to each trainee individual and is assigned in a manner such as that previously described with reference to FIG. 1. For example, the system may assign a random identification code, e.g., a password that ties each particular trainee individual 18 to worker specific training information applicable thereto by way of the linking information. However, the administrator individual 14 may also assign passwords under certain circumstances or the passwords may be assigned in any other known manner for uniquely identifying each trainee individual and tying them to their individualized worker specific training information. It will be recognized that any identification code, e.g., employee number, social security number, etc., may be used and that the present invention is not limited to a password being assigned.

With the identification code available to a particular trainee individual 18, the trainee individual 18 may access the application server architecture 12 to receive training. As shown in block 70 of FIG. 2, the trainee individual may log into the system 10 using the identification code as provided by the administrator individual 14 and using the interface device 20 as illustrated in FIG. 1. For example, the trainee individual 18 may access the application server architecture 12 using a web browser.

Upon logon, at least in one embodiment, the trainee individual 18 is optionally presented with certain worker specific information (block 74). For example, such information may include the trainee individual's department or, for example, a drawing of a particular respirator for which the trainee is to be trained.

Prior to receiving training using the standardized program in combination with worker specific training information, the trainee is asked to confirm such information (block 76). If the trainee individual 18 does not confirm such information, then no further information is provided and, in some manner (e.g., e-mail notification, telephone, etc.), the administrator individual 14 is notified (block 78). As such, a trainee individual 18 is not provided with training that relates to inapplicable training material.

However, if the trainee individual 18 confirms that such information is accurate, then the trainee individual 18 receives worker specific training using the standardized training program 38 populated with selected worker specific training information available from database 40 that is linked to the trainee individual 18 by the administrator individual 14 (block 82). Block 80 shows the worker specific training information available in the training system 10 for use in populating the generic shell provided with use of the standardized training program depending upon the training objects for which the trainee individual 18 is to be trained.

The training (block 82) is provided with use of the trainee interface device 20 (see FIG. 1). A user interface is provided to the trainee individual 18 using the standardized program 38 in association with the particular training information corresponding to at least one training object selected from the worker specific training information based on at least the identification code and the linking information for the trainee individual who is logged into the application server architecture 12. Various specific examples of the user interface shall be described further herein with reference to FIGS. 3-7. However, generally, the user interface provided to the trainee individual 18 displays at least a portion of the particular worker specific training information corresponding to a training object for which the trainee individual 18 is to be trained. Further, the user interface may require the trainee individual 18 to provide one or more responses concerning the displayed worker specific training information.

The worker specific information selected to populate the shell interface provided with use of the standardized program 38 to individualize the training for the trainee individual may include various types of training information depending on the workplace condition and the linking information provided by the administrator individual 14. For example, in one embodiment, the worker specific training information may include information corresponding to an environmental hazard (e.g., hazard communication information relating to a particular chemical, air contaminant, industrial hygiene, etc.). For example, in another embodiment, the training information may include information corresponding to a particular type of safety equipment (e.g., respirator equipment, hearing protection devices and hearing loss prevention control equipment, physical body support equipment, eye and face protection, head protection, foot protection, and skin protection, etc.).

In one embodiment where the worker specific training information corresponds to a configuration for a type of safety equipment, the user interface may include a populated training shell containing information relating to the maintenance of the particular configuration of safety equipment (e.g., information on when to replace a respirator part). Further, for example, the trainee individual may be required to provide one or more responses concerning the information related to the maintenance of the safety equipment. In one particular embodiment, an illustration of a respirator that is operational and an illustration of a respirator that has a problem associated therewith may be displayed to the trainee individual. The trainee individual may then be requested to identify the problem (e.g., a broken strap, punctured cartridge, etc.), such as by selecting the problem area on the illustration using a mouse.

In a like manner, the particular configuration of the type of safety equipment may be displayed to show, for example, the various features thereof. Again, the trainee individual may be required to provide one or more responses concerning the illustration. In one particular illustrative example, a particular make and model of a respirator may be provided and displayed in the user interface. The trainee individual may be required to identify one or more parts of the make and model of the respirator equipment.

Further, information regarding the use of a particular type of safety equipment may be displayed. For example, such information may be with regard to the donning and doffing of a particular type of safety equipment. In other words, information regarding the placement of the equipment on an individual and taking the safety equipment off may be provided. In one particular example of such a displayed user interface, an unordered list of steps for wearing the particular configuration of safety equipment may be displayed with a requirement that a trainee individual 18 order the list of steps.

Yet in a further embodiment, for example, the worker specific training information used to populate the shell provided by the standardized training program 38 may correspond to a particular configuration of a respirator (e.g., a particular make, model, and any specified component such as a filter or cartridge of a respirator). In such an embodiment, where the worker specific information corresponds to a particular make and model of respirator equipment, the worker specific information may include visual information showing the respirator, audio information explaining how to don the respirator, usage information, storage information, maintenance information, and/or various other types of information such as that described further herein with reference to FIGS. 3-7.

One will recognize that the worker specific information that may be used to populate the generic shell is of an abundance and that any information that would be beneficial for training the trainee individual 18 with respect to a particular workplace condition may be used.

Following the training of the trainee individual 18 (block 82), the trainee individual's training session may be verified and recorded (block 86). For example, responses made by the trainee individual 18 may be considered and analyzed to determine if an understanding of a piece of safety equipment is acceptable. Further, such verification and recordation of the trainee individual's session may be recorded for reporting purposes to outside sources, such as OSHA. Further, after finishing the training, the trainee individual 18 may log out of the application server architecture 12 (block 88).

The following description with reference to FIGS. 3-7 provide one illustrative embodiment of at least portions of a particular training system 100 (other portions may be shown more generally in FIG. 1) and a respirator training method 150 relating to respirator equipment. This illustrative embodiment is intended to provide some additional detail forming a clearer understanding of the general embodiments shown and described with reference to FIGS. 1 and 2.

The respirator training system 100 as shown in FIG. 3 may be generally implemented in the same manner as described with reference to FIG. 1. The respirator training system 100 includes respirator training engine 104 which is a standardized training program that uses information (as shown by block 108) provided by the administrator individual 114 to select information from a database 106 including worker specific training information corresponding to each of a plurality of different configurations of respirator. For example, as shown by database 106, such worker specific training information may include information about the following topic areas relating to each particular configuration of the respirators (e.g., model and make of respirator). Such topic areas may include, for example: when and why to use a respirator, a fit test introduction, donning and doffing the respirator, inspection of the respirator, maintenance of the respirator, usage of the respirator, storage of the respirator, and disposal of the respirator. Further, for example, such worker specific information may include company information, OSHA regulations, or any other elements pertaining to the respirator or workplace condition that an individual is required to wear a respirator.

The administrator individual 114 interfaces with the administrator module 110 that presents a user interface to the administrator individual 114 such that suitable information can be input by the administrator individual 114. Such administrator information (e.g., workplace information) may include, for example, trainee identification information, linking information, etc., as shown in block 108.

A trainee 120 once provided with an identification code 112 may access the respirator training engine or program 104 which is used to provide a user interface to the trainee individual 120 by way of interface device 115 (e.g., web browser). As will be described further herein, the respirator training program 104 is used to provide a generic shell that can be populated with information from worker specific training information as shown generally in block 106 to provide an individualized training program with information specific to the trainee individual 120 who is accessing the standard respirator training engine 104.

In one embodiment of the respirator training system 100, user tracking data 117 is collected and/or recorded (e.g., stored) for use in various functions related thereto. For example, user tracking data 117 may include completion data 130 representative of the completion of training by one or more trainee individuals. Further, such user tracking data 117 may include response analysis data 132 representative of an analysis of one or more trainee individuals' responses during the training program for determination of whether suitable training has been received by the trainee individuals 120. Likewise, one or more additional types of information 134 may include track fit testing information, medical evaluation information relating to whether trainee individuals can actually receive training with respect to a particular respirator, or any other information that may benefit the users of the system 100.

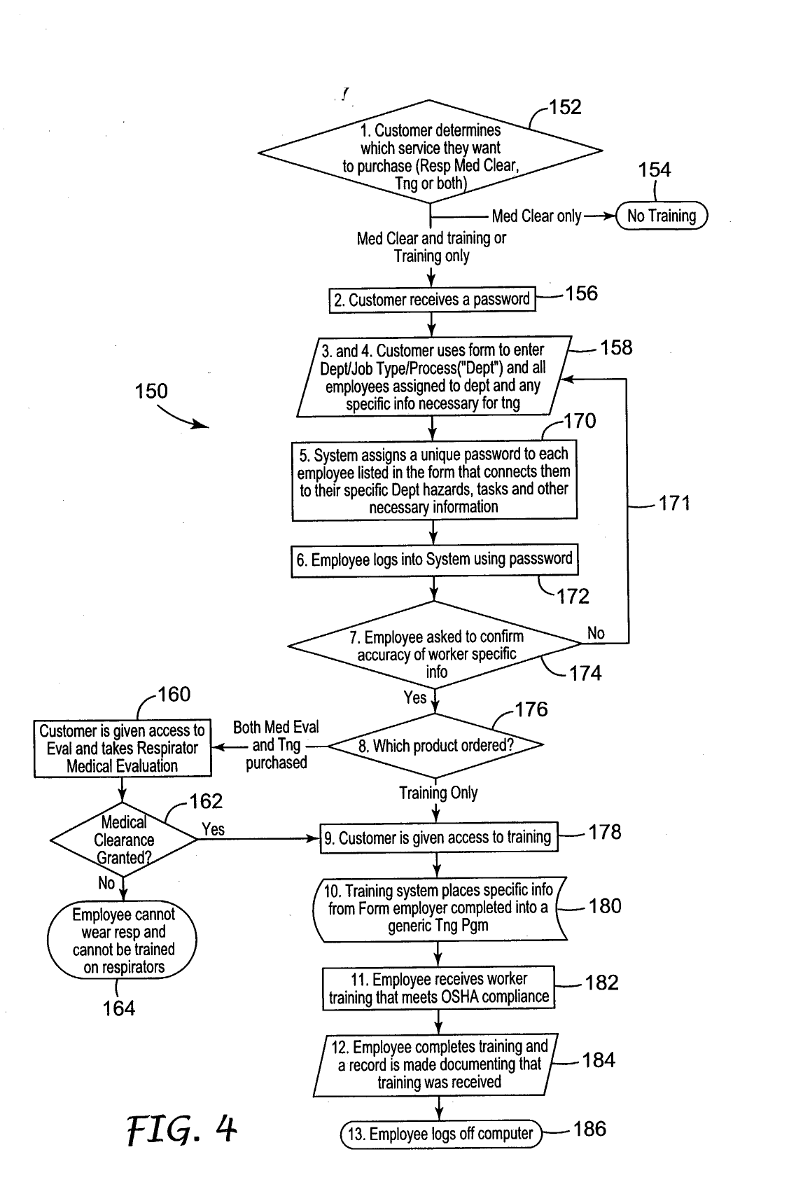

The respirator training method 150 that may be implemented using the respirator training system 100 as shown in FIG. 3 is shown in the flow diagram of FIG. 4. The respirator training method 150 is initiated with a customer determining which of a plurality of services they wish to purchase (block 152), for example, from a company that is managing the training system and components thereof. For example, as shown in FIG. 1, the standardized training program 38, or according to FIG. 3, the respirator training engine or program 104 may be used with other complimentary programs 36. For example, such programs may include a program like the 3M™ Respirator Medical Evaluation Program as described at www.mmm.com/occsafety/html/respirator_medical_clearance.html which may be used in combination with the respirator training program 104. Further, for example, compliance type software programs like the 3M™ Health and Safety Software described at the website //products3.3m.com/catalogue/us/en001/safety/occ_health_safety/node for use in managing respiratory protection programs (e.g., tracking OSHA compliance) may be used in combination with the respirator training program 104.

In one embodiment, for example, both a medical clearance program and a training program are available. In such an embodiment, if, for example, the customer determines to only do a medical clearance, then only access (e.g., a password) to the medical clearance program is provided to the customer and no respirator training program access is provided (block 154). If, for example, a customer determines they wish to use both medical clearance software and the respirator training program, or just the respirator training program, then the customer receives a password to allow the customer to have access to the application server architecture that provides such functionality (block 156).

Such a customer ordering process may include any type of communication with the company or manager of the application server architecture providing the training program used to implement the present invention. For example, a customer may enter an online ordering system and determine which services they wish to purchase (e.g., respirator medical clearance, respirator training, or both). The password provided to the customer ties the customer to its specific order and any information that may be collected in relation thereto (e.g., tracking information, etc.). It will be recognized that the information collected with respect to particular customers will have security measures attached to prevent access by other customers. One or more various types of security configurations may be used as would be known to one skilled in the art.

With the customer's identification access rights (e.g., password), the customer can log onto the application server architecture, or a limited portion thereof. For example, an administrator individual 114 associated with the customer may log on and is presented with a user interface using the administrator module 110. The user interface is used to provide the administrator individual 114 with a mode to enter administration information (e.g., trainee identification information, linking information, etc.) such that respiratory training engine 104 may be suitably used for training a designated trainee individual 120. Generally, in one embodiment of the user interface, the administrator individual 114 will be requested (e.g., with one or more queries) to provide various workplace information such as discussed below.

For example, in one embodiment, as shown by block 158, the administrator individual 114 may be presented with a job information form relating to their specific order after entering the password provided to the customer. The requested information in the form may include information with regard to workplace conditions for various departments, job descriptions or processes at a particular facility. As an example, specific information provided by the administrator individual 114 may include:

1. Name and internal telephone number of the respirator program administrator individual.

2. Air contaminants for each department listed.

3. Permissible exposure limits of the air contaminants listed.

4. Form of contaminant (e.g., vapor, solid, gas).

5. Effects of exposure (shortness of breath, etc.).

6. Engineering or administrative controls with exposure levels taken before and after controls put in place.

7. Respirator make and model including cartridges, filters, or both.

8. Selection criteria used to determine the respirator.

9. Responsibilities of specific personnel under the site respiratory protection program.

10. Change schedules for the respirator.

11. Company policies for: respirator use, maintenance, inspection, cleaning, storage and disposal.

12. Method of fit testing.

13. Medical clearance schedule.

14. Emergency respirator use procedures and information on where escape respirators can be found.

15. Any additional aspects of the site respiratory protection program that an administrator individual 114 would deem beneficial to the trainee individual 120.

Further, administrator individual 114 then lists the trainee individuals that are assigned to each department, job description or process. In this manner, administrator individual 114 is linking each of the trainee individuals 120 to specific training objects (e.g., effects of exposure, one particular make and model of respirator, disposal for a respirator, etc.) for which the particular trainee individual is to be trained. With such administrator information, the respirator training engine 104 can select particular worker specific training information corresponding to a particular respirator make and model along with inspection, maintenance, and other information corresponding to such a respirator make and model for use in populating the generic shell of the user interface provided using the standardized respiratory training program 104.

In one embodiment, information may be provided in drop boxes to make it easier for the administrator individual 114 to define training objects or workplace conditions for department job types or processes. For example, information with regard to a plurality of configurations for respiratory equipment (e.g., the five most common brands of respirators) may be put into the system. When the administrator individual 114 is asked to specify a respirator make and model for an individual, a list of specific respirator part numbers may be displayed and the administrator individual 114 may be able to choose the respirator that the particular trainee individual is to use.

The respirator training system 100 assigns to each trainee individual 120 a password (block 170) that ties them (e.g., via the linking information provided by the administrator individual) to particular worker specific training information, which in this embodiment includes worker specific training information corresponding to a particular respiratory make and model. The password for each trainee individual 120 may be provided to such individuals by any method (e.g., e-mail, mail, or any other kind of notification system).

A trainee individual 120 (e.g., an employee as shown in the embodiment of FIG. 4) may log into the system 100 (e.g., part of an application server architecture such as that shown in FIG. 1) using the password provided thereto (block 172). Upon logging into the system 100, an introduction screen may be presented to the trainee individual 120 using certain worker specific information. The trainee individual 120 is asked to confirm the accuracy of the certain worker specific information (block 174).

One exemplary introduction screen 200 is shown in FIG. 5 for respiratory protection training. Generally, the user interface includes shell information 202 which is the standardized portion of the introduction screen 200 that is generally provided as part of the user interface to all trainee individuals which are to be trained using the respiratory training system 100. The shell information 202 is populated with various worker specific information 204, 206 tied to the particular trainee individual 120 whose password was used to log onto the system 100.

As shown in FIG. 5, the shell information 202 includes general information introducing the respiratory training information to the user and the worker specific information 204 includes information such as the trainee individual's name, the administrator individual, the particular configuration of respirator that the trainee individual is to wear and for which training is being provided, the company name, etc. For example, as shown in FIG. 5, worker specific information includes the language “3M Half Facepiece Respirator with CARTRIDGES.” Further for example, it is indicated that the trainee individual 120 works in the “maintenance” area of the “ABC Company.” In addition, the trainee individual 120 is provided with worker specific information 206 that includes a visualization of the respirator which the trainee individual 120 is to wear.

With the introduction screen 200 provided by the user interface to the trainee individual 120 that is logged onto the system 100, the trainee individual can verify in region 205 whether the information is correct or whether the information is incorrect. By responding to the request of the user interface, if the information is correct, then depending upon which product has been order (e.g., training only or both a medical evaluation and training), as shown in block 176, the process continues as shown therein. If the trainee individual 120 indicates that the information provided in the introduction screen 200 is incorrect, then as shown by line 171, the administrator individual 114 is contacted (e.g., to provide different respirator or other administrator information).

If the information is correct, and if a medical evaluation is to be provided in conjunction with respirator training, then access is given to an evaluation program. The trainee individual undertakes the respirator medical evaluation as shown in block 160. If the trainee individual logged onto the system is not granted medical permission to wear a particular respirator (block 162) then the employee is notified that such a respirator cannot be worn and no training is provided for the respirator (block 164). If medical clearance is granted (block 162), then the trainee individual 120 is given access to the remainder of the training process, e.g., the respiratory training of block 178.

As the training process continues per block 178 for the trainee individual 120, the respiratory training program 104 selects and downloads worker specific training information based on the identification code (e.g., password) for the trainee individual 120 logged onto the system 100 and the linking information provided by the administrator individual 114 linking the trainee individual 120 to a particular training object such as the 3M half faceplate respirator with cartridges as shown in FIG. 5. In other words, the trainee individual 120 is provided with a user interface using the standardized respirator training program 104 in association with particular training information selected from the worker specific training information available in database 106 as linked to the training individual 120 by the administrator individual 114. The information downloaded which is specific to the trainee individual 120 logged onto the system 100 may take various forms. For example, such information may be a simple communication, may include audio or visual information, may be provided as an interactive subroutine, may be provided as an interactive subroutine designed to determine whether the trainee individual has an understanding with regard to the respirator for which she is being trained, etc. Further, as show in FIG. 3, such information may relate to all the elements 140 previously described with reference thereto.

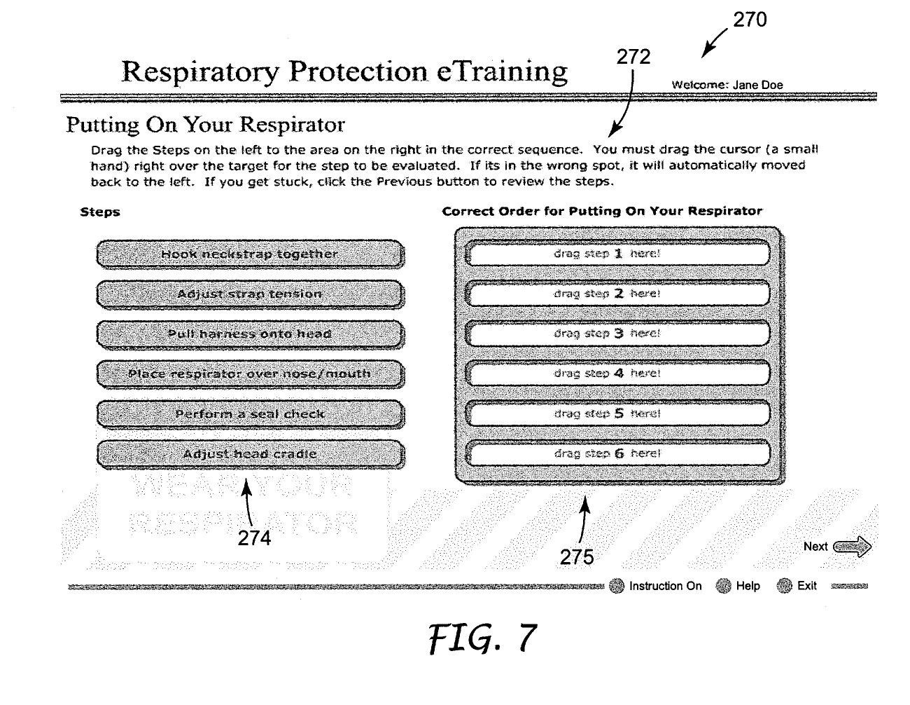

Several exemplary embodiments of a shell user interface being populated with worker specific training information are illustratively shown in FIGS. 6 and 7. FIG. 6 shows a respirator parts identification screen 230 which includes a generic shell 231 capable of being populated with worker specific information 232 and 233. For example, the shell 231 provides instructions to a trainee individual 120 with respect to the screen 230. In this case, the trainee individual 120 is to identify all the parts by clicking on their name in the parts list 232 provided as worker specific training information by visually inspecting the graphical representation of the respirator 233 which the trainee individual 120 is to wear. In such a manner, it can be determined whether the trainee individual 120 understands the various details of the respirator that the trainee individual 120 is to use.

FIG. 7 provides a donning respirator screen 270 that includes a shell 272 providing standardized text along with other worker specific training information 274-275. The text of the shell 272 provides instructions to the trainee individual 120. Using this screen 270, the trainee individual 120 is required to reorder an unordered list 274 or steps for donning the particular respiratory. The trainee individual 120 is requested to drag the steps from the unordered list 274 to a correct position in the ordered list.

One skilled in the art will recognize that various types of exemplary training using a standardized generic shell portion that may be populated with various worker specific training information can be designed within the scope of the present invention. Such a populated user interface provided to the trainee individual with information that is specifically applicable to the worker provides a training capacity without subjecting the trainee individual to unnecessary information (e.g., information that may be applicable to training a different individual in the same workplace).

After the trainee individual 120 has completed the training program (block 182), a record is made documenting that the training has been received (block 184). Such record may be made when the trainee individual 120 (e.g., employee) logs out of the training system 100 (block 186).

As will be generally recognized from the description herein, in one embodiment of the present invention, a method for worker specific occupational health and safety training is provided utilizing automated selection of workplace conditions and equipment use recommendations. The process involves employee information that is electronically queried from an administrator individual at the workplace who has knowledge of the various workplace conditions. The information is processed through an occupational health and safety based information algorithm that responds with a customized training program that includes workplace practices and conditions, and where applicable protective equipment recommendations. Workplace practices might include aspects of regulatory compliance, description of the nature of the applicable workplace hazards, custom site driven compliance requirements, and links to training coordinators and training modules. Equipment related recommendations might include instructions on proper fit, use and maintenance, in addition to, the functional capabilities and limitations of a training object. The information algorithm might address single or multiple occupational safety requirements relating to respiratory, hearing, vision, and environmental isolation, or other protective needs. The algorithm can be tailored for individual workplace environments such as manufacturing, laboratory, healthcare, military, or any other environment that may benefit from the advantages provided by the methods and systems described herein.

All references and patents disclosed herein are incorporated by reference in their entirety as if each were individually incorporated. Various modifications and alterations of this invention will become apparent to those skilled in the art without departing from the scope of the invention, and it should be understood that this invention is not to be unduly limited to the illustrative embodiments and processes set forth herein.

What is claimed is:

1. A method for use in training individuals, the method comprising:
providing a standardized training program and worker specific training information, wherein the worker specific training information comprises information corresponding to each of a plurality of different training objects for at least one workplace condition;
allowing one or more administrative individuals to provide workplace information associated with a workplace, wherein the workplace information comprises:
trainee identification information identifying a plurality of trainee individuals, wherein each of the plurality of trainee individuals is to be trained with respect to at least one training object of the plurality of different training objects for the at least one workplace condition that is associated with the workplace; and
linking information for each of the plurality of trainee individuals, wherein the linking information provides an association between the trainee individual and the at least one training object;
assigning an identification code to each of the plurality of trainee individuals that allows each trainee individual to access the standardized training program, wherein the identification code is unique to each trainee individual; and
providing a user interface to at least one of the plurality of trainee individuals using the standardized training program in association with particular training information corresponding to the at least one training object selected from the worker specific training information based on at least the identification code and the linking information for the at least one trainee individual.

2. The method of claim 1, wherein the information corresponding to each of a plurality of different training objects for at least one workplace condition comprises information corresponding to each of a plurality of different types of environmental hazards.

3. The method of claim 1, wherein the information corresponding to each of a plurality of different training objects for at least one workplace condition comprises information corresponding to each of a plurality of different configurations for a type of safety equipment.

4. The method of claim 3, wherein information corresponding to each of a plurality of different configurations for a type of safety equipment comprises information corresponding to each of a plurality of different configurations for at least one of respirator equipment, hearing protection and hearing loss prevention control equipment, physical body support equipment, eye and face protection equipment, head protection equipment, foot protection equipment, and skin protection equipment.

5. The method of claim 4, wherein information corresponding to each of a plurality of different configurations for a type of safety equipment comprises information corresponding to each of a plurality of configurations of respirator equipment.

6. The method of claim 1, wherein providing a user interface comprises:
displaying at least a portion of the worker specific training information; and
requiring that the at least one trainee individual verify the accuracy of the at least a portion of the worker specific training information.

7. The method of claim 1, wherein providing a user interface comprises:
displaying at least a portion of the particular training information corresponding to the at least one training object for which the at least one trainee individual is to be trained; and
requiring the at least one trainee individual to provide one or more responses concerning the portion of the particular training information.

8. The method of claim 7, wherein the portion of the particular training information comprises information corresponding to at least one type of environmental hazard.

9. The method of claim 7, wherein the portion of the particular training information comprises information corresponding to a particular configuration for a type of safety equipment.

10. The method of claim 9, wherein the portion of the particular training information comprises information corresponding to a particular configuration of respirator equipment.

11. The method of claim 7, wherein the method further comprises verifying at least the one or more responses from the at least one trainee individual, and upon completion of the verification, recording whether the trainee individual has completed training associated with the at least one training object.

12. The method of claim 1, wherein the particular training information comprises information corresponding to a particular configuration for a type of safety equipment for which the at least one trainee individual is to be trained, and further wherein providing a user interface comprises:
providing information related to the maintenance of the particular configuration of safety equipment; and
requiring the at least one trainee individual to provide one or more responses concerning the information related to the maintenance of the safety equipment.

13. The method of claim 1, wherein the particular training information comprises information corresponding to a particular configuration of a type of safety equipment for which the at least one trainee individual is to be trained, and further wherein providing a user interface comprises:
displaying an illustration of the particular configuration of the type of safety equipment; and
providing the trainee individual with information that requires one or more responses from the trainee individual concerning the illustration.

14. The method of claim 13, wherein displaying an illustration of the particular configuration of the safety equipment comprises displaying an illustration of a configuration of respirator equipment.

15. The method of claim 14, wherein providing the at least one trainee individual with information that requires one or more responses comprises providing the at least one trainee individual with information that requires the at least one trainee individual to identify one or more parts of the configuration of respirator equipment using the illustration thereof.

16. The method of claim 1, wherein the particular training information comprises information corresponding to a particular configuration of a type of safety equipment for which the at least one trainee individual is to be trained, and further wherein providing a user interface comprises:
displaying information associated with wearing the particular configuration of safety equipment; and
requiring the at least one trainee individual to provide one or more responses concerning the information.

17. The method of claim 1, wherein information corresponding to each of a plurality of different training objects for at least one workplace condition comprises information corresponding to each of a plurality of configurations of at least one type of safety equipment, and wherein the method further comprises:
providing information associated with a medical evaluation of whether a trainee individual can wear the at least one type of safety equipment; and
preventing the at least one trainee individual from being trained using the user interface based on the information associated with the medical evaluation.

18. A computer implemented system for use in training individuals, the computer implemented system comprising:
at least one application server operable for communicating with one or more databases and further operable for communicating with one or more user computers;
a standardized training program; and
worker specific training information stored in at least one of the databases, wherein the worker specific training information comprises information corresponding to each of a plurality of different training objects for at least one workplace condition; and
wherein the computer implemented system is operable for use in providing:
an administrative interface on at least one of the user computers adapted to provide one or more administrative individuals having access to the at least one application server to allow the one or more administrative individuals to provide workplace information associated with a workplace, wherein the workplace information comprises:
trainee identification information identifying a plurality of trainee individuals, wherein each of the plurality of trainee individuals is to be trained with respect to at least one training object of the plurality of training objects for the at least one workplace condition that is associated with the workplace; and
linking information for each of the plurality of trainee individuals, wherein the linking information provides an association between the trainee individual and the at least one training object;
and further wherein the computer implemented system is operable to provide:
assignment of an identification code to each of the plurality of trainee individuals that allows each trainee individual to access the application server, wherein the identification code is unique to each trainee individual; and
a user interface adapted for use in training at least one of the plurality of trainee individuals using the standardized training program in association with particular training information corresponding to the at least one training object selected from the worker specific training information based on at least the identification code and the linking information for the at least one trainee individual.

19. The system of claim 18, wherein the information corresponding to each of a plurality of different training objects for at least one workplace condition comprises information corresponding to each of a plurality of different types of environmental hazards.

20. The system of claim 18, wherein the information corresponding to each of a plurality of different training objects for at least one workplace condition comprises information corresponding to each of a plurality of different configurations for a type of safety equipment.

21. The system of claim 20, wherein information corresponding to each of a plurality of different configurations for a type of safety equipment comprises information corresponding to each of a plurality of different configurations for at least one of respirator equipment, hearing protection and hearing loss prevention control equipment, physical body support equipment, eye and face protection equipment, head protection equipment, foot protection equipment, and skin protection equipment.

22. The system of claim 21, wherein information corresponding to each of a plurality of different configurations for a type of safety equipment comprises information corresponding to each of a plurality of configurations for respirator equipment.

23. The system of claim 18, wherein the user interface is adapted to display at least a portion of the worker specific training information and require that the at least one trainee individual verify the accuracy of the at least a portion of the worker specific training information.

24. The system of claim 18, wherein the user interface is adapted to display at least a portion of the particular training information corresponding to the at least one training object for which the at least one trainee individual is to be trained and require the at least one trainee individual to provide one or more responses concerning the portion of the particular training information.

25. The system of claim 24, wherein the user interface is adapted to display at least a portion of the particular training information corresponding to a particular configuration for a type of safety equipment.

26. The system of claim 25, wherein the user interface is adapted to display at least a portion of the particular training information corresponding to a configuration of respirator equipment.

27. The system of claim 24, wherein the system is further operable to verify at least the one or more responses from the at least one trainee individual, and upon completion of the verification, record whether the trainee individual has completed training associated with the at least one training object.

28. The system of claim 18, wherein the particular training information comprises information corresponding to a particular configuration of a type of safety equipment for which the at least one trainee individual is to be trained, and further wherein the user interface is adapted to provide information related to the maintenance of the particular configuration of safety equipment and require the at least one trainee individual to provide one or more responses concerning the information related to the maintenance of the safety equipment.

29. The system of claim 18, wherein the particular training information comprises information corresponding to a particular configuration of a type of safety equipment for which the at least one trainee individual is to be trained, and further wherein the user interface is adapted to display an illustration of the particular configuration of the type of safety equipment and provide the trainee individual with information that requires one or more responses from the trainee individual concerning the illustration.

30. The system of claim 29, wherein the user interface is adapted to display an illustration of a configuration of respirator equipment.

31. The system of claim 29, wherein the user interface is adapted to provide the at least one trainee individual with information that requires the at least one trainee individual to identify one or more parts of the configuration of respirator equipment using the illustration thereof.

32. The system of claim 18, wherein the particular training information comprises information corresponding to a particular configuration of a type of safety equipment for which the at least one trainee individual is to be trained, and further wherein the user interface is adapted to display information associated with wearing the particular 10 configuration of safety equipment and require the at least one trainee individual to provide one or more responses concerning the information.

33. The system of claim 18, wherein information corresponding to each of a plurality of different training objects for at least one workplace condition comprises information corresponding to each of a plurality of configurations of at least one type of safety equipment, and wherein the system is further operable to receive information associated with a medical evaluation of whether a trainee individual can wear the at least one type of safety equipment and adapted to prevent the at least one trainee individual from being trained using the user interface based on the information associated with the medical evaluation.

34. A user interface for use in training individuals provided using a standardized training program and worker specific training information, wherein the worker specific training information comprises information corresponding to each of a plurality of different training objects for at least one workplace condition, wherein the user interface comprises an administrative interface adapted to allow one or more administrative individuals to provide workplace information associated with a workplace, wherein the workplace information comprises:
trainee identification information identifying a plurality of trainee individuals, wherein each of the plurality of trainee individuals is to be trained with respect to at least one training object of the plurality of training objects for at least one workplace condition that is associated with the workplace; and
linking information for each of the plurality of trainee individuals, wherein the linking information provides an association between the trainee individual and the at least one training object; and
further wherein an identification code is assigned to each of the plurality of trainee individuals that allows each trainee individual to access the standardized training program, wherein at least the identification code and the linking information for at least one trainee individual is used in providing a user interface using the standardized training program in association with particular training information corresponding to the at least one training object selected from the worker specific training information.

35. The user interface of claim 34, wherein the information corresponding to each of a plurality of different training objects for at least one workplace condition comprises information corresponding to each of a plurality of different types of environmental hazards.

36. The user interface of claim 34, wherein the information corresponding to each of a plurality of different training objects for at least one workplace condition comprises information corresponding to each of a plurality of different configurations for a type of safety equipment.

37. The user interface of claim 36, wherein information corresponding to each of a plurality of different configurations for a type of safety equipment comprises information corresponding to each of a plurality of different configurations for at least one of respirator equipment, hearing protection and hearing loss prevention control equipment, physical body support equipment, eye and face protection equipment, head protection equipment, foot protection equipment, and skin protection equipment.

38. The user interface of claim 37, wherein information corresponding to each of a plurality of different configurations for a type of safety equipment comprises information corresponding to each of a plurality of configurations of respirator equipment.

39. An online training system, the system comprising:
a user computer apparatus;
at least one application server operable for communicating with one or more databases and further operable for communicating with the user computer apparatus;
a standardized training program; and
worker specific training information stored in at least one of the one or more databases, wherein the worker specific training information comprises information corresponding to each of a plurality of different training objects for at least one workplace condition; and
wherein the online training system through use of the application server is operable to provide:
an administrative interface adapted to provide one or more administrative individuals with access to the application server to allow the one or more administrative individuals to provide workplace information associated with a workplace, wherein the workplace information comprises:
trainee identification information identifying a plurality of trainee individuals, wherein each of the plurality of trainee individuals is to be trained with respect to at least one training object of the plurality of training objects for the at least one workplace condition that is associated with the at least one workplace; and
linking information for each of the plurality of trainee individuals, wherein the linking information provides an association between the trainee individual and the at least one training object, wherein an identification code is assigned to each of the plurality of trainee individuals that allows each trainee individual to access the standardized training program; and
a user interface provided using the user computer apparatus for use in training the at least one trainee individual using the standardized training program in association with particular training information corresponding to the at least one training object selected from the worker specific training information based on at least the identification code and the linking information for the at least one trainee individual.

40. The system of claim 39, wherein the information corresponding to each of a plurality of different training objects for at least one workplace condition comprises information corresponding to each of a plurality of different configurations for a type of safety equipment.

41. The system of claim 40, wherein information corresponding to each of a plurality of different configurations for a type of safety equipment comprises information corresponding to each of a plurality of different configurations for at least one of respirator equipment, hearing protection and hearing loss prevention control equipment, physical body support equipment, eye and face protection equipment, head protection equipment, foot protection equipment, and skin protection equipment.

42. The system of claim 41, wherein information corresponding to each of a plurality of different configurations for a type of safety equipment comprises information corresponding to each of a plurality of configurations of respirator equipment.

43. The system of claim 39, wherein the user interface is adapted to display at least a portion of the particular training information corresponding to the at least one training object for which the at least one trainee individual is to be trained and require the at least one trainee individual to provide one or more responses concerning the portion of the particular training information.

44. An online training method, the method comprising:
establishing a communication link between a user computer apparatus and an application server, wherein the application server provides a standardized training program and worker specific training information, wherein the worker specific training information comprises information corresponding to each of a plurality of different training objects for at least one workplace condition;
using an identification code assigned to a trainee individual to access the standardized training program; and
providing a user interface on the user computer apparatus to the at least one trainee individual using the standardized training program in association with particular training information corresponding to at least one training object of the plurality of training objects selected from the worker specific training information based on at least the identification code.

45. The method of claim 44, wherein information corresponding to each of a plurality of different training objects comprises information corresponding to each of one or more configurations for at least one type of safety equipment, and further wherein providing the user interface comprises using the standardized training program in association with particular training information corresponding to a particular configuration of the one more configurations for the at least one type of safety equipment selected from the worker specific training information based on at least the identification code.

46. The method of claim 45, wherein information corresponding to each of a plurality of different training objects comprises information corresponding to each of one or more configurations of respirator equipment.

47. The method of claim 45, wherein providing a user interface comprises:
displaying at least a portion of the worker specific training information; and
requesting that the at least one trainee individual verify the accuracy of the at least a portion of the worker specific training information.

48. The method of claim 45, wherein providing a user interface comprises:
providing information related to the maintenance of the particular configuration of the type of safety equipment; and
requiring the at least one trainee individual to provide one or more responses concerning the information related to the maintenance of the type of safety equipment.

49. The method of claim 45, wherein providing a user interface comprises:
displaying an illustration of the particular configuration of the type of safety equipment; and
providing the trainee individual with information that requires one or more responses from the trainee individual concerning the illustration.

50. The method of claim 49, wherein displaying an illustration of the particular configuration of the type of safety equipment comprises displaying an illustration of a configuration of respirator equipment.

51. The method of claim 50, wherein providing the at least one trainee individual with information that requires one or more responses comprises providing the at least one trainee individual with information that requires the at least one trainee individual to identify one or more parts of the configuration of respirator equipment using the illustration thereof.

52. The method of claim 45, wherein providing a user interface comprises:
displaying information associated with wearing the particular configuration of safety equipment; and
requiring the at least one trainee individual to provide one or more responses concerning the information.

53. A method for use in training individuals, the method comprising:
providing a standardized training program and worker specific training information, wherein the worker specific training information comprises information corresponding to each of a plurality of different configurations for a type of safety equipment;
allowing one or more administrative individuals to provide workplace information associated with a workplace, wherein the workplace information comprises:
trainee identification information identifying a plurality of trainee individuals, wherein each of the plurality of trainee individuals is to be trained with respect to at least one configuration of the plurality of different configurations for the type of safety equipment; and
linking information for each of the plurality of trainee individuals, wherein the linking information provides an association between the trainee individual and the at least one configuration;
assigning an identification code to each of the plurality of trainee individuals that allows each trainee individual to access the standardized training program; and
providing a user interface to at least one of the plurality of trainee individuals using the standardized training program in association with particular training information corresponding to the at least one configuration selected from the worker specific training information based on at least the identification code and the linking information for the at least one trainee individual.

54. The method of claim 53, wherein information corresponding to each of a plurality of different configurations for a type of safety equipment comprises information corresponding to each of a plurality of different configurations for at least one of respirator equipment, hearing protection and hearing loss prevention control equipment, physical body support equipment, eye and face protection equipment, head protection equipment, foot protection equipment, and skin protection equipment.

55. The method of claim 54, wherein information corresponding to each of a plurality of different configurations for a type of safety equipment comprises information corresponding to each of a plurality of configurations of respirator equipment.

56. The method of claim 53, wherein providing a user interface further comprises:
displaying at least a portion of the worker specific training information; and
requiring that the at least one trainee individual verify the accuracy of the at least a portion of the worker specific training information.

57. The method of claim 53, wherein providing a user interface comprises:
displaying at least a portion of the particular training information corresponding to the at least one configuration for which the at least one trainee individual is to be trained; and
requiring the at least one trainee individual to provide one or more responses concerning the portion of the particular training information.

58. The method of claim 57, wherein the portion of the particular training information comprises information corresponding to a particular configuration of respirator equipment.

59. The method of claim 57, wherein providing a user interface further comprises:
providing information related to the maintenance of the at least one configuration of safety equipment; and
requiring the at least one trainee individual to provide one or more responses concerning the information related to the maintenance of the safety equipment.

60. The method of claim 53, further wherein providing a user interface comprises:
displaying an illustration of the at least one configuration of the type of safety equipment; and
providing the trainee individual with information that requires one or more responses from the trainee individual concerning the illustration.

61. The method of claim 60, wherein displaying an illustration comprises displaying an illustration of a configuration of respirator equipment.

62. The method of claim 61, wherein providing the at least one trainee individual with information that requires one or more responses comprises providing the at least one trainee individual with information that requires the at least one trainee individual to identify one or more parts of the configuration of respirator equipment using the illustration thereof.

63. The method of claim 53, further wherein providing a user interface comprises:
displaying information associated with wearing the at least one configuration of safety equipment; and
requiring the at least one trainee individual to provide one or more responses concerning the information.

64. A computer implemented system for use in training individuals, the computer implemented system comprising:
at least one application server operable for communicating with one or more databases and further operable for communicating with one or more user computers;
a standardized training program; and
worker specific training information stored in at least one of the databases, wherein the worker specific training information comprises information corresponding to each of a plurality of different configurations for a type of safety equipment; and
wherein the computer implemented system is operable for use in providing:
an administrative interface on at least one of the user computers adapted to provide one or more administrative individuals having access to the at least one application server to allow the one or more administrative individuals to provide workplace information associated with a workplace, wherein the workplace information comprises:
trainee identification information identifying a plurality of trainee individuals, wherein each of the plurality of trainee individuals is to be trained with respect to at least one configuration for the type of safety equipment; and
linking information for each of the plurality of trainee individuals, wherein the linking information provides an association between the trainee individual and the at least one configuration; and
further wherein the computer implemented system is operable to provide:
assignment of an identification code to each of the plurality of trainee individuals that allows each trainee individual to access the application server; and
a user interface adapted for use in training at least one of the plurality of trainee individuals using the standardized training program in association with particular training information corresponding to the at least one configuration selected from the worker specific training information based on at least the identification code and the linking information for the at least one trainee individual.

65. The system of claim 64, wherein information corresponding to each of a plurality of different configurations for a type of safety equipment comprises information corresponding to each of a plurality of different configurations for at least one of respirator equipment, hearing protection and hearing loss prevention control equipment, physical body support equipment, eye and face protection equipment, head protection equipment, foot protection equipment, and skin protection equipment.

66. The system of claim 65, wherein information corresponding to each of a plurality of different configurations for a type of safety equipment comprises information 10 corresponding to each of a plurality of configurations for respirator equipment.

67. The system of claim 64, wherein the user interface is adapted to display at least a portion of the worker specific training information and require that the at least one trainee individual verify the accuracy of the at least a portion of the worker specific training information.

68. The system of claim 64, wherein the user interface is adapted to display at least a portion of the particular training information corresponding to the at least one configuration for which the at least one trainee individual is to be trained and require the at least one trainee individual to provide one or more responses concerning the portion of the particular training information.

69. The system of claim 68, wherein the user interface is adapted to display at least a portion of the particular training information corresponding to a configuration of respirator equipment.

70. The system of claim 64, further wherein the user interface is adapted to provide information related to the maintenance of the at least one configuration of safety equipment and require the at least one trainee individual to provide one or more responses concerning the information related to the maintenance of the safety equipment.

71. The system of claim 64, further wherein the user interface is adapted to display an illustration of the at least one configuration of the type of safety equipment and provide the trainee individual with information that requires one or more responses from the trainee individual concerning the illustration.

72. The system of claim 71, wherein the user interface is adapted to display an illustration of a configuration of respirator equipment.

73. The system of claim 72, wherein the user interface is adapted to provide the at least one trainee individual with information that requires the at least one trainee individual to identify one or more parts of the at least one configuration of respirator equipment using the illustration thereof.

74. The system of claim 64, further wherein the user interface is adapted to display information associated with wearing the at least one configuration of safety equipment and require the at least one trainee individual to provide one or more responses concerning the information.
